(19) United States
(12) Patent Application Publication
(10) Pub. No.: US 2008/0057983 A1
(43) Pub. Date: Mar. 6, 2008

(54) APPARATUS, AND ASSOCIATED METHOD, FOR CONFIGURING A PAGE MESSAGE USED TO PAGE AN ACCESS TERMINAL IN A RADIO COMMUNICATION SYSTEM IN WHICH EXTRA PARTIAL IDENTITY BITS ARE EXTRACTED FROM THE PAGE MESSAGE

(75) Inventor: WILLIAM DANIEL WILLEY, GILROY, CA (US)

Correspondence Address: DOCKET CLERK, PO BOX 12608, DALLAS, TX, 75225, US

(73) Assignee: RESEARCH IN MOTION LIMITED, WATERLOO, ON (CA)

(21) Appl. No.: 11/850,146

(22) Filed: Sep. 5, 2007

Related U.S. Application Data
(60) Provisional application No. 60/824,558, filed on Sep. 5, 2006.

(51) Int. Cl. H04Q 7/20

(52) U.S. Cl. 455/458

(57) ABSTRACT

Apparatus and an associated method for facilitating paging of access terminals by way of a quick page message. A determination is made of the number of additional partial identity bits, if any, that are available to be conveyed as part of a page message. In a page message with partial identities, extra bits of the identities can be extracted based upon the order of the partial identities in the message. Extra partial identity bits are made available based upon ordering of partial identities in a page message.

### CROSS REFERENCE TO RELATED APPLICATIONS

The present invention claims the priority of provisional patent application No. 60/824,558, filed on Sep. 5, 2006, the contents of which are incorporated herein by reference.

The present invention relates generally to a manner by which to page an access terminal of a radio communication system to alert the access terminal of a pending call, or other communication. More particularly, the present invention relates to apparatus, and an associated method, by which to form a quick page message that reduces problems with false entry of an access terminal into an improper state in response to the quick page message.

### BACKGROUND OF THE INVENTION

Advancements in communication technologies have permitted the development and deployment of new types of communication systems and communication services. Cellular telephony, and associated communication services available therethrough, are popularly utilized by many, typically providing users with communication mobility and also provides the capability of communications when the use of wireline communication systems would not be practical or possible.

While early-generation, cellular communication systems provided primarily for voice communications and only limited data communication services, newer-generation systems increasingly provide for high-speed data communication services at variable data communication rates. A CDMA2000, cellular communication system that provides for EV-DO services is an exemplary type of new-generation, cellular communication system that provides for high-speed data services. Operational details and protocols defining communications and operational requirements of devices of the system are set forth in an operating standard specification. Various aspects of operation of the CDMA2000 EV-DO communication scheme remain to be standardized and certain parts of the existing standard specification are considered for amendment. Various successor-generation communication schemes are also undergoing standardization and yet others are envisioned to be standardized.

For instance, a revision to the standard specification, release B of the CDMA2000 EV-DO specification standard defines a quick paging channel (QPCH) available upon which to broadcast access-terminal pages by an access network (AN) to an access terminal (AT). The QPCH was adopted in industry contributions 3GPP2 C20-20060323-013R1 and 3GPP2 C20-20060323-003R1 and published in 3GPP2 document C.S0024-B V1.0. Generally, pages are broadcast by the access network to an access terminal to alert the access terminal of a pending communication. And by so alerting the access terminal, the access terminal performs actions to permit the effectuation of the communication. Page indications broadcast upon the quick paging channel are broadcast in a manner that facilitates reduced battery consumption of the access terminal by reducing the battery consumption of the battery of the access terminal. Increased battery longevity is provided, reducing the rate at which a battery of the access terminal must be recharged. The access terminal is, as a result, able to be operated for a greater period of time between recharging or battery replacement. The aforementioned promulgations provide for broadcast of a message including page indications upon a physical logical layer that is monitored by the access terminal. The access terminal monitors the QPCH prior to monitoring the control channel to receive regular, control channel MAC (medium access control) messages such as page messages. A quick page message is broadcast upon the QPCH.

In one configuration, the quick page message contains quick page indicators. The quick page message includes a number of quick page indicator slots populated with the quick page indicators that indicate whether an access terminal is being paged. An exemplary configuration of a scheme that utilizes page indications is set forth, for instance, in industry contribution 3GPP2 C20-20060731-033. In this configuration, during operation, a mobile station hashes to a quick page indicator location, i.e., slot, within the quick page message based upon a session seed, i.e., a 32-bit pseudorandom number. If the quick page indicator of the quick page indicator slot to which the access terminal hashes indicates that the access terminal is not being paged, the access terminal enters into a sleep state, a reduced-power state, in which the access terminal does not remain powered at a level to receive the regular control channel MAC messages. Power savings is particularly significant in the event that the control channel MAC messages are lengthy and span multiple control channel frames or capsules.

In another configuration, a partial hash comparison scheme is provided. In the disclosed partial hash comparison scheme, the access network forms a quick page message in which a portion of a hash of an access terminal identifier (ATI) of an access terminal that is paged is placed in the quick page message. An access terminal that monitors for the delivery of a quick page message, reads the content of the message and compares the values with corresponding values, that is, portions of a hash of the identifier of that access terminal. If the values do not match, then the access terminal enters into a reduced power state, e.g., a sleep state.

The QPCH message, as presently-proposed, provides thirty-five page indication locations, i.e., bits available to be populated with paging indicators. The aforementioned “partial hash comparison” scheme utilizes three of the thirty-five page indication locations for identifying the number of pages, and the remaining page indication locations are available for paging, viz., are available. While the proposed, partial hash comparison scheme reduces the false wakeup probability when paging load is relatively low, when the paging load increases, the reduction in the available page indication locations actually increases the possibility of false wakeup. When more than five access terminals are paged, partial hash comparison is not used due to this increased possibility. Instead, hashing to page indication locations is performed.

Industry contribution 3GPP2 C22-20060825-003 also discloses a scheme pertaining to a quick page message. In this contribution, additional partial identity bits are conveyed by way of the ordering of partial identities in the quick page message. An ordering of partial identity bits is chosen in the message based upon next most significant bits of the partial identities. The ordering is relative to the ordering of the values beginning with a smallest partial identity and thereafter continuing with bigger partial identities. A quick page message, so-formed, is broadcast and detected by an access terminal. The access terminal reads the values and determines which ordering is conveyed in the message based upon the values of partial identities contained therein. And, the access terminal then appends bits corresponding to derived values of the partial identity bits received in the message. However, in this existing scheme, the number of orderings is equal to a factorial of the number of pages in the message. The factorial relationship between the number of pages and the number of orderings causes the number of orderings quickly to become a very large value as the number of pages increases.

Additionally, this scheme might cause an access terminal falsely to enter into a sleep state, resulting in the access terminal missing its page in a subsequently-sent regular page message. This problem occurs, for instance, when the number of possible orderings does not correspond to the factorial of the number of pages. For instance, if more than one access terminal, having the same most significant ten partial identity bits, is paged in a quick page message, the number of possible orderings would be reduced. As access terminals are paged at random, this occurrence is likely to be quite frequent when the quick page message includes large number of pages. Specifically, in the contribution, the access network chooses from the partial identity orderings from 1 to 6 according to three more partial identity bits not contained in the partial identity fields. When the access terminal that receives a quick paging message, so-formed, the access terminal determines the ordering and applies the extra bits in its partial identity comparison in the manner set forth in the contribution. However, the access terminal is susceptible to making a mistake as the access terminal shall sometimes extract incorrect bits and thus falsely enter into a sleep mode even though, in actuality, the access terminal is being paged.

An improved manner is therefore required to reduce, or eliminate, the possibility that the access terminal shall extract incorrect bits and enter into a sleep state when, instead, the access terminal is being paged.

It is in light of this background information related to paging by an access network of an access terminal that the significant improvements of the present invention have evolved.

### BRIEF DESCRIPTION OF THE DRAWINGS

FIG. 1 illustrates a functional block diagram of a radio communication system in which an embodiment of the present invention is operable.

FIG. 2 illustrates a diagram representative of a procedure performed pursuant to operation of an embodiment of the present invention.

FIG. 3 illustrates a method flow diagram of an embodiment of the present invention.

FIG. 4 illustrates a representation of exemplary paging, and occurrence of partial wakeup, pursuant to various paging schemes, including the paging scheme using a set structure pursuant to an embodiment of the present invention.

FIG. 5 illustrates a representation of paging of three access terminals pursuant to a scheme in which additional partial identity bits are conveyed by way of the ordering of the partial identities in a quick page message.

FIG. 6 illustrates a representation of occurrence of a false entry of an access terminal into a sleep mode.

FIG. 7 illustrates a representation in which the number of possible orderings of the partial identities is adjusted pursuant to operation of an embodiment of the present invention.

### DETAILED DESCRIPTION

The present invention, accordingly, advantageously provides an apparatus, and an associated method, by which to page an access terminal of a radio communication system to alert the access terminal of a pending call, or other communication.

Through operation of an embodiment of the present invention, a manner is provided by which to form a quick page message that reduces problems with false entry of an access terminal into an improper state in response to the quick page message.

Improved quick paging is provided that lessens the likelihood of false entry of the access terminal into a sleep state, thereby to cause the access terminal to miss its page on a regular paging channel.

In another aspect of the present invention, a partial identity scheme is utilized in the quick paging procedure. The partial identity comparison utilizes parts of access terminal identifiers (ATIs) or other numbers that are associated with access terminals that are paged. The portion of the ATI, or other number, that is included in the quick page message comprises, for instance, a selected number of most significant bits of the number. The length of the portion of the number included in the quick page message is dependent upon one or more factors.

As the length of the quick page message is prescribed, e.g., is of a thirty-five bit length, the lengths of the parts of the ATIs or other numbers included in the quick page message are limited by this prescribed length. If multiple pages are contained in the quick page message, only fractional portions of the parts of the ATIs or other numbers are able to be included in the quick page message. When the number of pages increases, the size, i.e., lengths, of the parts of the numbers that are includable in the quick page message are reduced.

A first portion of the quick page message, such as a first, three-bit portion, identifies the number of pages in the message. If the quick page message is of a length of thirty-five bits, and, e.g., the number of page indications is three-bits in length, then the number of bits available to identify the access terminals is reduced to thirty-two of the thirty-five bits. When a single access terminal is paged, all thirty-two bits are available by which to identify the paged access terminal. When two access terminals are paged, half of the thirty-two available bits are available to identify each of the two access terminals being paged. Analogously, when three access terminals are paged, one-third of the thirty-two bits are available to identify each of the three access terminals being paged. Because three does not divide into thirty-two equally, the number of bits available to identify different ones of the three access terminals is dissimilar. Or, one or more bits are not utilized to identify the paged access terminals. Analogous divisions and distributions are provided for higher numbers of paged access terminals.

In another aspect of the present invention, a determination is first made of the number of pages that are to be included in the quick page message. And, the corresponding parts of ATIs or other numbers that are used to identify the paged access terminals are configured. The most significant bits, for instance, of the number known to both the access terminal and the access network are used. For example, parts of the ATIs are utilized. For example, if sixteen bits are available to identify an access terminal, such as when the quick page message is to page two access terminals, the sixteen most significant bits of the number are utilized. If preferred, least significant bits are instead utilized. A comparator compares the values that identify the access terminals. In the event that the values identifying the different access terminals that are to be paged correspond, then redundant values are deleted by a redundant page value remover. The bits that would otherwise need to be provided for population with the redundant values are able, instead, to be utilized for other purposes. For instance, in the event that seven access terminals are to be paged and three of the seven access terminals are identified with ATIs that have most significant bits of the same values, the redundant values need not be included in the quick page message but, instead, the five unique sets of values are included in the quick page message.

In a further aspect of the present invention, all of the bit locations of the quick page message available to identify access terminals are used. The number of bits available to identify each access terminal need not be equal. For instance, if three access terminals are to be paged in the quick page message, two of the terminals are identified with ten bit values while a third of the access terminals is identified with an eleven bit-length value. Through use of all of the available parts of the quick page message, false wakeup of an access terminal is proportionately less likely to occur.

In these and other aspects, therefore, an apparatus, and an associated method, is provided for an access network of a communication network that generates a first page message on a first paging channel. A determiner is configured to determine page values of each page identifier set of each page intended to be included in the first page message. A redundant page value remover is configured selectably to remove page values intended to be included in the first page message that are redundant to page values of another page identifier set, if any, also intended to be part of the first page message. The first page message is formed of page value sets selectably free of page value set redundancies.

In these and further aspects, an apparatus, and an associated method, is provided for an access terminal that monitors a first paging channel for delivery of a first paging message. A number-of-pages detector is configured to detect how many page identifier sets are included in the first paging message. A page identifier set value detector is configured to detect values of each page identifier set detected by the number-of-pages detector to be included in the first paging message. The first paging message is selectably free of page value set redundancies.

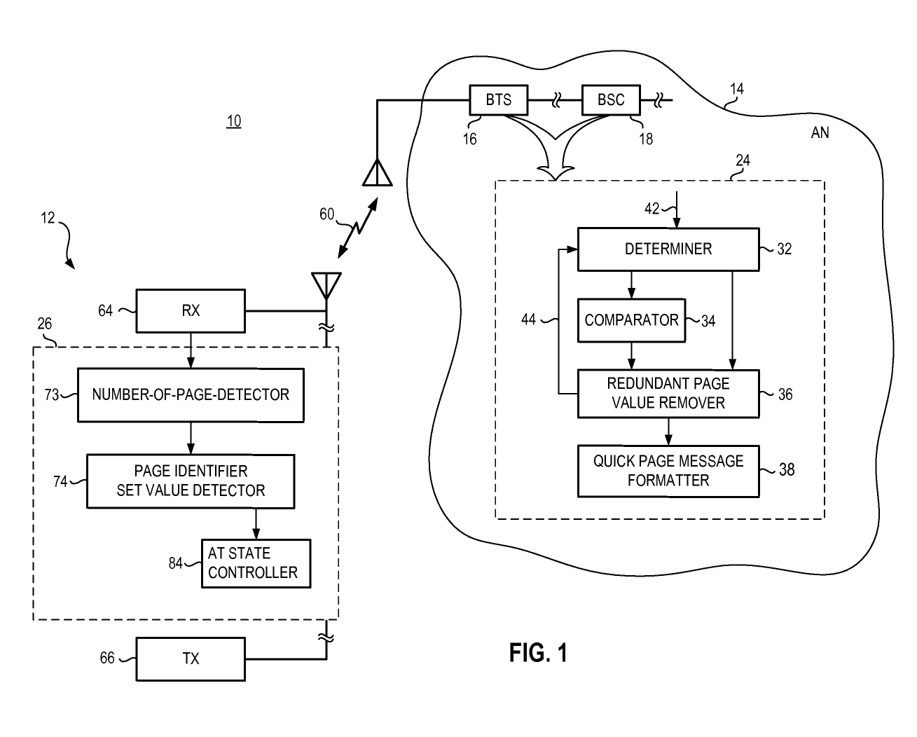

Referring first, therefore, to FIG. 1, a radio communication system, shown generally at 10, provides for communications with access terminals, of which the access terminal 12 is exemplary. The communication system forms a multi-user communication system that typically includes a large number of access terminals and a plurality of concurrent communication dialogs. While only a single access terminal is shown in FIG. 1, additional access terminals, analogous to the access terminal 12, typically form a portion of the communication system.

Communications are effectuated between an access terminal and a radio network 14, formed of fixed network infrastructure elements, such as a base transceiver station (BTS) 16 and a base station controller (BSC) 18. The access network encompasses a geographical area within which communications with the access network are possible. That is to say, when an access terminal is positioned within the area encompassed by the access network, the access terminal is generally able to communicate with the access network, and the access network is typically able to communicate with the access terminal.

The communication system is operable in general conformity with the operating protocols and parameters of an appropriate communication specification standard. The description set forth herein is exemplary, and the teachings of various embodiments of the present invention are implementable in any of various types of communication systems.

As previously mentioned, access terminals are alerted, by broadcast of a page message when a communication, initiated at the network, is to be terminated at an access terminal. A quick paging channel (QPCH), or analogous channel, is defined. Information contained in a quick page message broadcast on the quick paging channel identifies access terminals that are paged. When an access terminal detects, from the quick page message, that the access terminal is paged, the access terminal further operates in anticipation of the page and subsequent communication. The access terminal, conversely, enters into a reduced-power consumption state, e.g., a sleep state if the access terminal does not detect that it is being paged. If the access terminal incorrectly determines that it is being paged, the access terminal falsely wakes up. And, increased levels of power are consumed by the access terminal, resulting in reduced battery longevity. The aforementioned partial hash comparison scheme is intended to reduce the likelihood of false wakeup of the access terminal, but, as presently implemented, provides advantages only when a quick page message pages five or fewer access terminals. Additionally, not all of the bits of a quick page message are fully utilized in every paging scenario, and the existing scheme, for this reason, is less than ideal.

Accordingly, pursuant to an embodiment of the present invention, the access network includes apparatus 24, and the access terminal includes apparatus 26, that operate pursuant to quick page message generation and quick page message receipt in manners that reduce the likelihood of occurrence of false wakeup relative to an existing partial hash comparison scheme. The elements of the apparatus 24 and of the apparatus 26 are functionally represented, implementable in any desired manner, including, for instance, by algorithms executable by processing circuitry.

The elements forming the apparatus 24 are implemented at any appropriate location of the access network, including, as illustrated, at the BTS 16 or BSC 18, or distributed amongst such entities, as well as others.

Here, the apparatus 24 includes a determiner 32, a comparator 34, a redundant page value remover 36, and a quick page message formatter 38.

The determiner 32 operates to determine page values of page identifier sets that are associated with access terminals that are to be paged in a quick page message. That is to say, the determiner is provided, here indicated by way of the lines 42, with the identities, such as by their ATIs, of the access terminals that are to be paged. The number of terminals that are paged is determinative of the lengths of the page identifier sets that are includable in the quick page message. When more pages are to be included in the page message, the lengths of the page identifier sets that identify each of the access terminals being paged are less than the lengths permitted when fewer numbers of access terminals are being paged. Most significant bits of the ATIs are used. And, the determiner 32 determines the parts of the ATIs that can be used, depending upon the number of pages to be included in the quick page message. If two pages are to be included in the quick page message, each page identifier set is of sixteen-bit lengths, the sixteen most significant bits of the ATIs. When numbers other than ATIs are used, analogous portions of such other numbers are, e.g., instead utilized. In the exemplary implementation in which thirty-two bits are available in which to identify the access terminals and three bits are used to identify the number of pages in the quick page message, the thirty-two bits are collectively available by which to be used to identify access terminals that are to be paged. Pursuant to a further embodiment of the present invention, in the event that the number of access terminals that are to be paged do not permit for an equal division of the thirty-two bits, unequal numbers of bits are allocated to identify different ones of the access terminals while fully utilizing all thirty-two available bits. For instance, when three access terminals are to be paged, one access terminal is identified with an eleven-bit length page identifier set while the other two access terminals are identified with ten-bit length page identifier sets.

Indications of the identifiers determined by the determiner 32 are provided to a comparator 34. The comparator 34 operates to compare the different values and to identify if any of the page identifier sets are of identical values. When parts of the ATIs are utilized, that is to say, the selected number of most significant bits of the ATIs of the access terminals that are to be paged are used, there is a possibility that the most significant bits identifying more than one access terminal are identical to the corresponding values that identify another access terminal. Operation of the comparator identifies such identical values.

Indications of comparisons made by the comparator are provided to the redundant page value remover 36. The redundant page value remover 36 removes values, that is to say, page identifier set bits that are redundant, freeing up bit space in the quick page message. In the exemplary implementation, upon removal of the redundant bit values, the determiner 32 is caused to redetermine the page values of the identifiers of the access terminals that are to be paged. Here, indication is provided to the determiner 32 by way of the line 44 of the removal of the redundant bit values and the need to redetermine the identifiers used to identify the paged access terminals. Upon removal of the redundant page values, increased bits are available to identify the access terminals that are paged or, the partial identity comparison scheme is able to be used when greater than five access terminals are to be paged. Redetermined values are provided by the determiner 32 to the redundant page value remover 36 and thereafter provided to the quick page message formatter 38. The quick page message formatter 38 forms the quick page message populated with page identifier sets that are selectably free of redundancies.

Transceiver elements of the base transceiver station 16 cause broadcast of quick page messages that have been formatted by the quick page message formatter 38. The messages are broadcast upon a radio air interface, represented in FIG. 1 by the arrow 62. The messages are delivered to access terminals, such as the access terminal 12, within reception range of the broadcast messages. The access terminal 12 includes transceiver circuitry, here represented by a receive part 64 and a transmit part 66. The receive part 64 operates to receive signals sent thereto, such as the quick page messages broadcast by the access network. And, certain of the detected signals are provided to the apparatus 26 embodied at the access terminal. Of significance here are detections of the quick page message broadcast by the access network.

The apparatus 26 includes a number-of-pages detector 72 and a page identifier set value detector 74. The elements are functionally represented, also implementable in any desired manner, including algorithms executable by processing circuitry. The detector 72 detects an indication in the quick page message of the number of pages that are included in the received quick page message. The number of pages are indicated in, e.g., and as noted above, a three-bit segment of the quick page message. Detection of such indication is used by the page identifier set value detector 74 in the detection of the page identifier sets, thereby to determine whether the access terminal is paged. Additional operation at the access terminal determines, in response to the number of pages detected by the page detector, the page value lengths of the page identifier set or sets contained in the quick page message. In the event that the detector detects the access terminal not to be paged, an indication is provided to an access terminal (AT) state controller 84 to cause the access terminal to be placed in a reduced-power state, e.g., a sleep mode. If a page is detected, conversely, an indication is provided to the state controller 84 and the controller causes the state of the access terminal to permit its further operation with respect to paging and further communication.

While the existing partial hash comparison scheme is used only when five or fewer access terminals are paged, operation of an embodiment of the present invention is potentially permitting of performance of a partial identity comparison scheme in the event that more than five access terminals are being paged, but one or more of the identifiers, that is, page identifier sets are identical. For example, if seven access terminals are being paged and three of the access terminals being paged have the same six bits as their most significant bits, the apparatus 24 operates to eliminate two of the three duplicate page identifier sets and is then able to include five six-bit page identifier sets, herein also referred to as hashes, using partial identity comparison. Otherwise, individual page indication bits are inserted in specified locations of the message, their locations being selected through operation of a hash function generator.

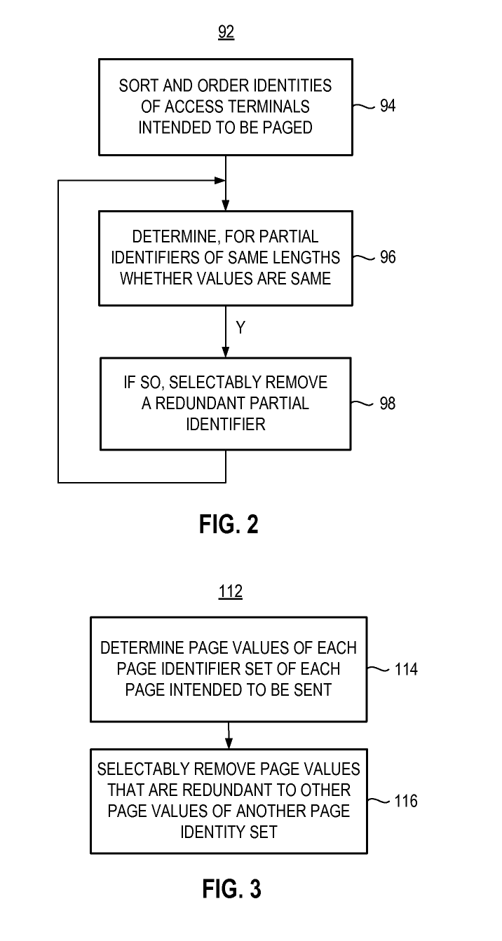

FIG. 2 illustrates a diagram, shown generally at 92, representative of a procedure performed at the apparatus 26, or otherwise at the access network, by which to eliminate duplicate values from a quick page message. First, and as indicated by the block 94, the identities are sorted and ordered with the process first commencing with identities having the largest lengths, that is to say, largest number of bits. Then, and as indicated by the decision block 96, a determination is made as to whether the identities of that number of bits, that is length, are of the same values. If so, the yes branch is taken and, as indicated by the block 98, a redundant identity value is removed. The process continues for so long as there are enough partial identities of the size to hold the remaining identities. If the number of partial identities at this size is the same as the number of identities that remain, the partial identities are filled into a message, and the process ends.

If the current number of bits of the partial identity is equal to the smallest number possible, then the partial identity comparison scheme is not utilized. Instead, paging indicators are utilized. As noted above, pursuant to exemplary operation, all bits of the quick page message are used even if unequal bit number allocations are made for paging different access terminals within a single page message. By doing so, the false wakeup probability is reduced. Additionally, partial bits of random or pseudorandom numbers known to both the access network and the access terminal are used for the reason that such values are sometimes more random than a hash value generated by a hash function. And, further, partial address bits are used for this reason rather than for partial hash bits.

FIG. 3 illustrates a method flow diagram, shown generally at 112, representative of the method of operation of an embodiment of the present invention. The method facilitates paging by an access network that selectably generates a first page message on a first paging channel.

First, and as indicated by the block 114, page values of each page identifier set of each page intended to be included in the first page message is determined. Then, and as indicated by the block 116, page values intended to be included in the first page message are selectably removed. The page values selected to be removed are those that are redundant to page values of another page identity set.

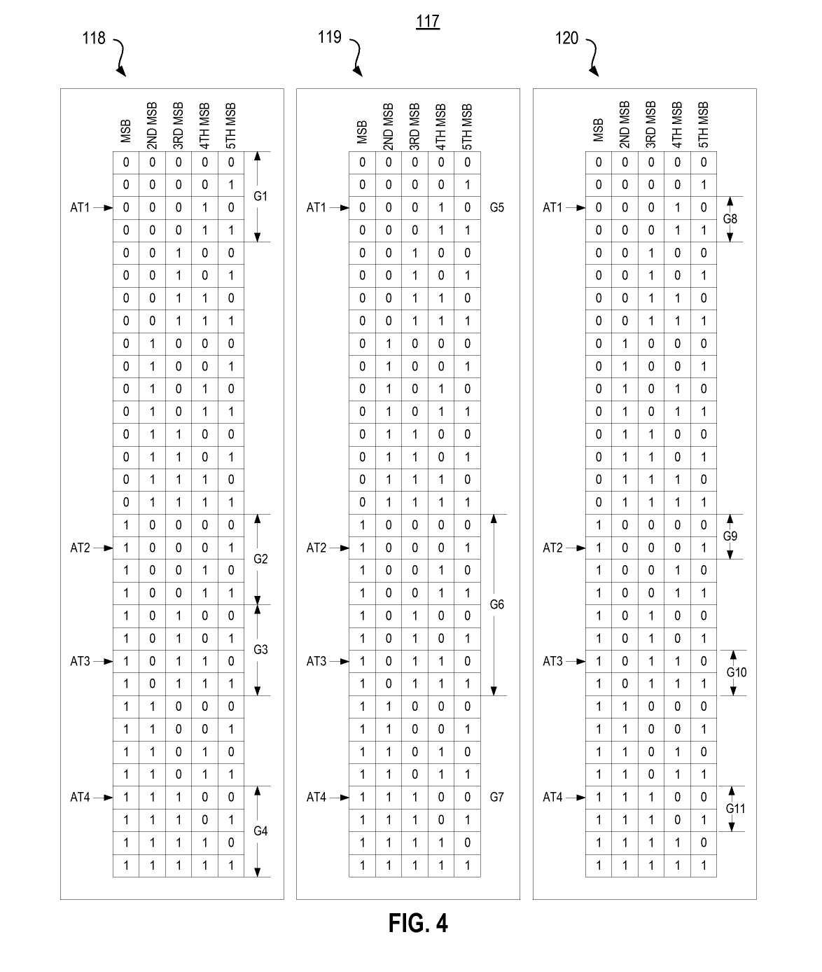

FIG. 4 illustrates a group, shown generally at 117, of partial identifiers that identify access terminals and occurrences of false wakeup of various of such access terminals pursuant to various quick paging schemes. Here, representations of three paging schemes are shown at 118, 119, 120. The first paging scheme is representative of a conventional partial comparison scheme in which partial identifiers contained in a paging message are all of equal-numbered bit lengths. The scheme 119 is representative of a scheme in which partial redundancies are removed to lessen the likelihood of false wakeup. And, the scheme 120 is representative of the scheme of an embodiment of the present invention in which set structures are utilized to minimize the occurrence of false wakeup.

The exemplary operations shown by the schemes 118, 119, and 120 are of operation in which a quick page message includes twelve bits available by which to identify all of the access terminals that are paged. Operation with respect to a quick page message that includes other numbers of available bits, such as the thirty-two bits described above, is analogous.

Additionally, in the examples of FIG. 4, four access terminals, access terminals AT1, AT2, AT3, and AT4, are paged. And, each grouping 118, 119, and 120 illustrates the five most significant bits (MSBs) of an identifier amenable to identify any of the access terminals. And, as indicated by the four access terminals, AT1, AT2, AT3, and AT4, the access terminal AT1 has as its most five significant partial identity bits of ‘00010’. Analogously, the access terminal AT2 is identified by its five most significant bits of ‘10001’. The access terminal AT3 has as its five most significant bits ‘10110’. And, the access terminal AT4 has as its five most significant bits the values ‘11100’.

In the example in which twelve bits are available in the quick page message and four access terminals are paged, the scheme of grouping 118 forms a quick page message in which three bits are available to each of the four access terminals, that is to say, twelve divided by four. In such a structure, the bits would be: ‘000’, ‘100’, ‘101’, and ‘111’. Such values correspond to the most significant bits, the three most significant bits, the access terminals AT1, AT2, AT3, and AT4, respectively. Groups identified as G1, G2, G3, and G4 identify access terminals that are awakened by the quick page. Sixteen of the access terminals are awakened, not merely the access terminals that are being paged.

The scheme represented by the grouping 119 reduces the occurrence of false wakeup relative to the scheme represented by the grouping 119. In this example, the four pages to the four access terminals are represented by three partial identities. One of the partial identities is chosen such that two of the partial identities will be of the same values, that is, be redundant. In this example, the access terminals AT2 and AT3 have the same most significant two partial identity bits while both the access terminals AT1 and AT4 differ more significantly in their respective most significant partial identity bits. Therefore, a structure here is used that allows the access terminals AT2 and AT3 to share two bits. The structure of the quick page message includes a first page of five bits, a second page of five bits, and a third page of two bits. And, the bits in the structure are of values in ‘00010’, ‘11100’, and ‘10’, corresponding to the access terminals AT1, AT4, and AT2/AT3, respectively.

Here, the groups G5, G6, and G7 are the groups of access terminals that are awakened by the quick page message. Groups G5 and G7 include only the access terminals AT1 and AT4, respectively. And, the group G6 includes values associated with eight access terminals. Comparison of the groupings 118 and 119 illustrates the improvement provided by the selection of the unequal bit lengths of the pages contained in the quick page message.

The grouping 120 represents paging in which a page message is formed of set structures. The structure is here used to match a smallest number of partial identities with various numbers of pages. For example, a ‘552’ structure is used, if desired, to page four access terminals if the most significant two partial identity bits of two access terminals are the same. The same ‘552’ structure is also usable to page five access terminals if the most significant two partial identity bits of the three access terminals are the same. In various scenarios, the added flexibility of being able to use a structure for additional numbers of pages does not necessarily provide substantial additional benefit. Through the use of set structures, the flexibility is lost, but, as illustrated in the example, further decrease in the likelihood of false wakeup. By way of an example, a ‘44211’ quick paging structure is used to represent the exemplary four pages of which two of the partial identifiers share the most significant two partial identity bits. This same structure would not be used, however, in an example of five pages of which three access terminals share common values of their two most significant partial identity bits. In this ‘44211’ structure, the values are: ‘0001 , ‘1110’, ‘10’, ‘0’, and ‘1’. The values ‘0001’ correspond to the four most significant bits of the access terminal AT1. The values ‘1110’ correspond to the four most significant bits of the partial identifier of the access terminal AT4. The values ‘10’ correspond to the values of the two most significant bits of the partial identifiers of the access terminals AT2 and AT3. And, the remaining bits, i.e., ‘0’ and ‘1’, represent less significant bits of the access terminals AT2 and AT3. It should be noted that a ‘543’ structure is also available and this structure would instead be used in the event of matches on the three most significant bits of two of the access terminals.

By the selection of the example, therefore, an assumption can be made that the access terminals AT2 and AT3 have third most significant bits of different values. Therefore, the first bit following the two-bit partial identifier set in the ‘44211’ set structure is assumed to be associated with the access terminal that has ‘0’ as its third most significant bit. Analogously, the last bit in the ‘44211’ structure is assumed to be associated with the access terminal that has the page value of ‘1’ as its third most significant bit. Therefore, the ‘0’ in the structure corresponds to the fourth most significant bit of the second access terminal, and the value in ‘1’ in the set structure corresponds to the fourth most significant bit of the third access terminal.

The groups G8, G9, G10, and G11 illustrate the groups of access terminals that are awakened by the quick page message of the aforementioned set structure. Here, a lessened number of access terminals are falsely awakened. Comparison of the access terminals awakened by the examples of the grouping 120 with the groupings 118 and 119 illustrates the further reduction in the false wakeup. Additional note is made pertaining to the ‘543’ structure briefly noted above. The set structure is not used, for example, if the number of possible structures is limited and the second-to-last and the last bits in the structure represent the third most significant bit of the access terminal AT2 and the third most significant bit of the access terminal AT3, respectively.

In this example, in the event that the ‘543’ set structure is available, the effect of the new structure is to specify four bits of each of the four access terminals even though only twelve bits are available. Two bits are duplicated for the two access terminals and two bits are implied. The effect is to compress the sixteen bits of the four access terminals into twelve bits. Even though an uneven number of bits is sent in the set structure for each of the four access terminals, in effect, four bits are represented for each access terminal. Preferably, an even number of bits is represented for each access terminal.

In the example of the ‘543’ structure, if a ‘444’ structure is available, the fourth most significant bits of the access terminals that match the three most significant bits are implied in the same way as described above for the fourth most significant bits.

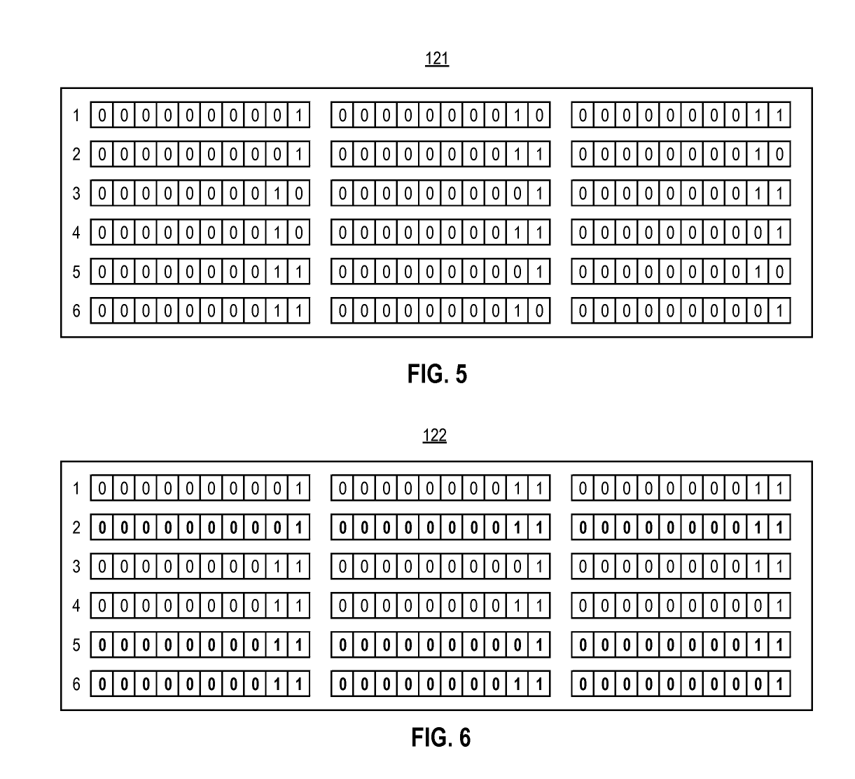

FIG. 5 illustrates a representation, shown generally at 121, representative of an example occurrence in which three access terminals are paged. The paged access terminals have most significant, partial identity bits of ‘00000000001’, ‘0000000010’, and ‘0000000011’. The access network chooses ordering of the partial identity bits in the message based upon next most significant bits of the partial identities. Partial identity ordering 1 in FIG. 5 is used to convey ‘0’, ‘0’, and ‘0’ for the three next most significant partial identity bits. The partial identity ordering 2, shown in FIG. 5, is used to convey ‘0’, ‘1’, and ‘0’ for three next most significant partial identity bits. The partial identity ordering 3 in FIG. 5 is used to convey ‘1’ and ‘0’ for the two next most significant partial identity bits. The partial ordering 4 shown in FIG. 5 is used to convey ‘1’ and ‘1’ for two next most significant partial identity bits. The partial identity ordering 5 shown in FIG. 5 is used to convey ‘0’, ‘0’, and ‘1’ for the three next most significant partial identity bits. And, the partial identity ordering 6, shown in FIG. 5, is used to convey ‘0’, ‘1’, and ‘1’, for the three next most significant partial identity bits. The ordering is relative to an ordering of the value sorted beginning with the smallest partial identity, and continuing with bigger partial identities, as shown by the ordering 1 in FIG. 5.

When delivered to an access terminal, the access terminal reads the values and determines which of the six orderings is conveyed in the message based upon the values of the three partial identities. The access terminal then appends bits corresponding to derived values to the partial identity bits received in the message. In a conventional scheme, there are only two possible orderings for the situation of two pages, six possible orderings for the situation of three pages, twenty-four possible orderings for the situation of four pages, and one hundred twenty possible orderings for the situation of five pages. The number of orderings is equal to a factorial of the number of (pages!).

FIG. 6 illustrates a representation, shown generally at 122, that again illustrates the partial identities of three access terminals that are paged. The representation 122 shows the problem that results in an access terminal falsely going to sleep responsive to the broadcast of a quick page message when, instead, the access terminal is paged. The problem results as the number of possible orderings does not always correspond to the factorial of the number of pages.

In the situation in which more than one access terminal has the same most significant ten partial identity bits is being paged in the quick page message, the number of possible orderings would be less. As the access terminals are paged at random, this situation shall occur, quite frequently, for larger numbers of pages. The representation 122 illustrates a situation where three access terminals are being paged and have the most significant partial identity bits in a ‘0000000001’, ‘0000000011’, and ‘0000000011’. In a conventional scheme, the access network chooses from the partial identity orderings from one to six, shown in FIG. 6, according to three more partial identity bits not conveyed in the partial identity fields. Rows in FIG. 6, i.e., rows 2, 5, and 6, represent duplicate orderings. The ordering 2, the second row, is the same as the ordering 1, the first row. The ordering 5 is the same as the ordering 3, the third row. And, the ordering 6 is the same as the ordering 4, the fourth row. When the access terminals determines the ordering and applies the extra bits in its partial identity comparison as set forth conventionally, the access terminal can make a mistake as the access terminal shall sometimes extract incorrect bits and thus falsely go to sleep even when the access terminal is being paged.

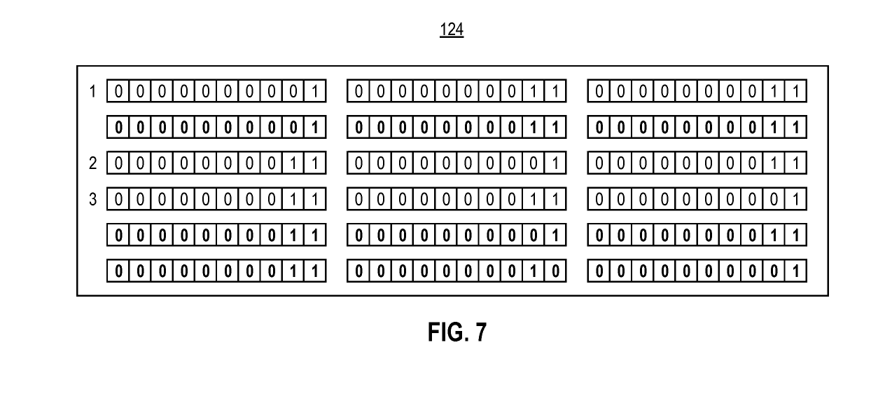

FIG. 7 illustrates a representation, shown generally at 124, illustrative of a manner by which the problem is solved pursuant to operation of an embodiment of the present invention. The number of possible orderings of the partial identities is adjusted. By this adjustment, the number of extra bits conveyed by way of ordering is also adjusted, all according to the number of identical partial identity fields contained in the quick page message.

When the access network creates the quick page message, a determiner first determines, based upon the partial identities of the paged access terminals, how many partial identity fields will be conveyed in the message. In the example shown in FIG. 7, there are two identical partial identity fields of ‘0000000011’ and one partial identity field of ‘0000000001’. The number of orderings is equal to a factorial of the number of pages divided by the product of the factorials of the numbers of identical partial identity fields.

In the example of FIG. 7, the number of orderings is 3!/2!=3. Based upon the number of orderings, in this example, three, the access network determines the number of additional partial identity bits that can be conveyed. In this example, two are conveyed half the time and one the other half of the time. In FIG. 7, the orderings 1, 2, and 3 illustrate the different orderings. The first ordering, ordering 1, is used to convey ‘0’ and ‘0’ for the two next most significant partial identity bits. The second ordering, ordering 2, is used to convey ‘0’ and ‘1’ for the two next most significant partial identity bits. The third ordering, ordering 3, is used to convey ‘1’ for one next most significant partial identity bit. After determining the ordering based upon next most significant partial identity bits, the access network constructs the quick page message according to the ordering and transmits the message to the access terminals on a quick paging channel.

Upon receipt of the quick page message, an access terminal reads the partial identity fields and uses the partial identity fields to determine the number of identical partial identity fields in the quick page message. The access terminal then determines the number of orderings and thus the number of additional partial identity bits conveyed in the message. The access terminal then extracts the additional bits based upon the order of the partial identity fields in the quick page message. The access terminal then concatenates the additional bits with the bits from the partial identity fields in the message and performs partial identity comparison to determine if the access terminal needs to listen for regular pages.

According to an exemplary implementation, there are many variations of the number of orderings. Some of the orderings are described assuming the quick page message that is conventionally generated, such as that described in the aforementioned contribution C20-20060731-033. In this contribution, cases with two, three, four, and five pages are shown. For the case of two pages, there are two possible orderings (2!)=2 when two partial identities are different. If both partial identities are identical, then there is only one possible ordering (2!)/(2!)=1. With only one possible ordering, no additional partial identity bits can be conveyed.

For the situation of three pages, there are six possible orderings (3!)=6 when the three partial identities are all different. If two of the three partial identities are identical, there are three possible orderings (3!)/(2!)=3. If all three of the partial identities are identical, there is one possible ordering (3!)/(3!)=1 and no additional partial identity bits can be conveyed.

For the situation of four pages, there are twenty-four possible orderings (4!)=24 when the four partial identities are all different. If three of the four partial identities are identical, there are four possible orderings (4!)/(3!)=4. If only two of the four partial identities are identical, there are twelve possible orderings (4!)/(2!)=12. If there are two different pairs of identical partial identities of the four partial identities, there are six possible orderings (4!)/(2!)(2!)=6. If all four of the partial identities are identical, there is one possible ordering (4!)/(4!)=1. And, no additional partial identity bits can be conveyed.

For the situation of five pages, there are one hundred twenty possible orderings (5!)=120 when the five partial identities are all different. If four of the five partial identities are identical, there are five possible orderings (5!)/(4!)=5. If only three of the five partial identities are identical, there are twenty possible orderings (5!)/(3!)=20. If only two of the partial identities are identical, there are sixty possible orderings (5!)/(2!)=60. If there are two different pairs of identical partial identities of the five partial identities, there are thirty possible orderings (5!)/(2!)(2!)=30. If there is one pair of identical partial identities and one triplet of partial identities in the five partial identities, there are ten possible orderings (5!)/(3!)(2!)=10. If all five of the partial identities are identical, there is one possible ordering (5!)/(5!)=1 and no additional partial identity bits can be conveyed. For each of the various numbers of orderings, there is an associate number of additional partial identity bits that can be conveyed via ordering.

The previous descriptions are of preferred examples for implementing the invention, and the scope of the invention should not necessarily be limited by this description.

What is claimed:

1. A method for facilitating access-terminal paging, said method comprising the:
determining a number of possible orderings of partial identities to be included in a portion of a page message; and
deciding how many additional partial identity bits are available to be conveyed via the portion of the page message responsive to the number of possible orderings.

2. The method of claim 1 wherein, if no additional partial identity bits are available to be conveyed, the page message is formed without conveying additional partial identity bits.

3. The method of claim 1 wherein, if at least one additional partial identity bit is available to be conveyed, the page message is configured in a manner that conveys at least one additional partial identity bit.

4. The method of claim 1 wherein the additional partial identity bits comprise derived bits.

5. The method of claim 1 wherein the page message comprises a quick page message.

6. The method of claim 1 wherein determining the number of possible orderings further comprises determining a number of possible unique orderings of the partial identities of the page message.

7. The method of claim 1 wherein determining the number of possible orderings comprises calculating a factorial of a number of the partial identities of the page message divided by a factorial of a number of partial identities of non-unique values.

8. The method of claim 7 wherein the additional partial identity bits correspond to a result of calculations performed during said operation of calculating.

9. Apparatus for facilitating access-terminal paging with a page message, said apparatus comprising:
an ordering determiner configured to determine a number of possible orderings of partial identities to be included in a portion of the page message; and
a bit determiner configured to determine how many additional partial identity bits are available to be conveyed via the portion of the page message responsive to the number of possible orderings determined by said ordering determiner.

10. The apparatus of claim 9 wherein, if said bit determiner determines that no additional partial identity bits are available to be conveyed, the page message is formed without conveying additional partial identity bits.

11. The apparatus of claim 9 wherein, if said bit determiner determines that at least one additional partial identity bit is available to be conveyed, the page message is configured in a manner that conveys the at least one additional bit.

12. The apparatus of claim 9 wherein the additional partial identity bits comprise derived bits.

13. The apparatus of claim 9 wherein the page message comprises a quick page message.

14. The apparatus of claim 9 wherein said ordering determiner is further configured to determine a number of unique orderings of the partial identities of the page message.

15. The apparatus of claim 9 wherein the number of possible orderings is derived from a factorial of a number of the partial identities of the page message divided by a factorial of a number of partial identities of non-unique values.

16. The apparatus of claim 15 wherein the additional partial identity bits determined by said bit determiner correspond to a result of the factorial.

17. A method for facilitating paging of an access terminal that receives a page message, said method comprising:
comparing at least two partial identity fields included in the page message; and
forgoing derivation of an additional partial identity bit if comparison made during said operation of comparing indicates the partial identity fields to be similar.

18. The method of claim 17 further comprising deriving at least one additional partial identity bit if comparison made during said operation of comparing indicates the partial identity fields to be dissimilar.

19. The method of claim 18 further comprising concatenating the at least one additional partial identity bit derived during said operation of deriving to a partial identity included in the page message.

20. Apparatus for facilitating paging of an access terminal that receives a page message, said apparatus comprising:
an included field determiner configured to determine how many partial identity fields that are included, and used for ordering, in at least one portion of the page message;
a possible orderings determiner configured to determine possible orderings of the partial identity fields that are included, and used for ordering; and
an identity bit determiner configured to determine whether the portion of the page message conveys at least one additional partial identity bit responsive to determination of the possible orderings determined by said possible orderings.

21. A method for facilitating access terminal paging, said method comprising:
forming a table listing all possible orderings of partial identities to be included in a portion of a page message;
eliminating duplicate orderings from the table; and
deciding how many additional partial identity bits are available to be conveyed via the portion of the page message responsive to listings in the table subsequent to elimination of the duplicate orderings.
